(19) United States
(12) Patent Application Publication
(10) Pub. No.: US 2024/0034165 A1
(43) Pub. Date: Feb. 1, 2024

(54) METHODS OF CHARGING A HYBRID VEHICLE BATTERY

(71) Applicant: Saudi Arabian Oil Company, Dhahran (SA)

(72) Inventors: Samusideen Adewale Salu, Ras Tanura (SA); Hussain M. Bayat, Saihat (SA); Ali Mohammad Abbas, Umm Al Hamam (SA)

(21) Appl. No.: 17/875,005

(22) Filed: Jul. 27, 2022

(51) Int. Cl. B60L 53/20; F01N 5/02; F01N 3/00; H01M 10/44

(52) U.S. Cl. CPC B60L 53/20; F01N 5/025; F01N 3/005; H01M 10/44; H01M 2220/20

(57) ABSTRACT

A method of charging a battery of a hybrid vehicle includes operating an engine of the hybrid vehicle using fuel to cause the hybrid vehicle to move. The method further includes, while the hybrid vehicle is moving, converting thermal energy within flue gas exhausted from the engine into electricity and charging the battery with the electricity.

### TECHNICAL FIELD

This disclosure relates to methods of charging a battery of a hybrid vehicle, such as hybrid vehicles that include a special organic rankine cycle (SORC) system.

### BACKGROUND

Hybrid vehicles typically include a battery that drives an electric motor and a fuel-based engine as separate sources of power. When the battery is charged, the hybrid vehicle is powered by electrical energy provided by the battery. On the other hand, when the battery is not charged, the hybrid vehicle is powered by fuel. The distance a hybrid vehicle can travel (e.g., about 25 miles) is significantly limited due to the limited amount of electrical energy that is available to charge the battery. Such energy is produced during a process of regenerative braking, during which the electric motor operates electrically in reverse and acts as a generator to charge the battery during vehicle coasting and breaking.

### SUMMARY

This disclosure relates to methods of charging a battery of a hybrid vehicle while the hybrid vehicle is running on fuel. In operation, the hybrid vehicle utilizes thermal energy (e.g., heat) carried by flue gas that has been exhausted from an engine of the hybrid vehicle to charge the battery. Accordingly, a hybrid vehicle system includes a special organic rankine cycle (SORC) system that captures and converts the thermal energy into electricity. In some embodiments, the hybrid vehicle system further includes a water recovery system that recovers water from the flue gas exhausted from the engine.

In one aspect, a method of charging a battery of a hybrid vehicle includes operating an engine of the hybrid vehicle using fuel to cause the hybrid vehicle to move. The method further includes, while the hybrid vehicle is moving, converting thermal energy within flue gas exhausted from the engine into electricity and charging the battery with the electricity.

Embodiments may provide one or more of the following features.

In some embodiments, the method further includes flowing the flue gas exhausted from the engine into an evaporator.

In some embodiments, the flue gas is relatively hot flue gas, and the method further includes vaporizing liquid refrigerant within the evaporator using heat from the relatively hot flue gas and releasing relatively cold flue gas from the evaporator.

In some embodiments, the method further includes maintaining a temperature difference of about 20° F. between the relatively hot flue gas and the relatively cold flue gas.

In some embodiments, the method further includes generating the electricity from vaporized refrigerant flowing from the evaporator.

In some embodiments, the method further includes flowing the vaporized refrigerant from the evaporator to a turbine, generating the electricity at a generator, and releasing the electricity from the generator to the battery.

In some embodiments, the method further includes condensing the vaporized refrigerant.

In some embodiments, a radiator system or an air conditioning system of the hybrid vehicle provides a cooling functionality.

In some embodiments, the hybrid vehicle further includes a special rankine organic cycle (SORC) system that includes the evaporator.

In some embodiments, the method further includes flowing refrigerant through a closed loop of the SORC system.

In some embodiments, the refrigerant includes R-717.

In some embodiments, the method further includes recovering water from the flue gas exhausted from the engine while the hybrid vehicle is moving.

In some embodiments, the method further includes cooling the flue gas exhausted from the engine in a water recovery system of the hybrid vehicle.

In some embodiments, the method further includes increasing a pressure of the flue gas prior to recovering the water.

In another aspect, a method of operating a hybrid vehicle includes operating an engine of the hybrid vehicle using fuel to cause the hybrid vehicle to move. The method further includes, while the hybrid vehicle is moving, converting thermal energy within flue gas exhausted from the engine into electricity, charging the battery with the electricity, and recovering water from the flue gas.

The details of one or more embodiments are set forth in the accompanying drawings and description. Other features, aspects, and advantages of the embodiments will become apparent from the description, drawings, and claims.

### DESCRIPTION OF DRAWINGS

FIG. 1 is a schematic diagram of an example hybrid vehicle system that includes an example special organic rankine cycle (SORC) system.

FIG. 2 is a schematic diagram of the example SORC system of FIG. 1.

FIG. 3 is a schematic diagram of an example hybrid vehicle system that includes the example SORC system of FIG. 1 and an example water recovery system.

FIG. 4 is a schematic diagram of the example SORC system of FIG. 3 and the example water recovery system of FIG. 3.

FIG. 5 is a flow chart illustrating an example method of charging a battery of the hybrid vehicle systems of FIGS. 1 and 3.

### DETAILED DESCRIPTION

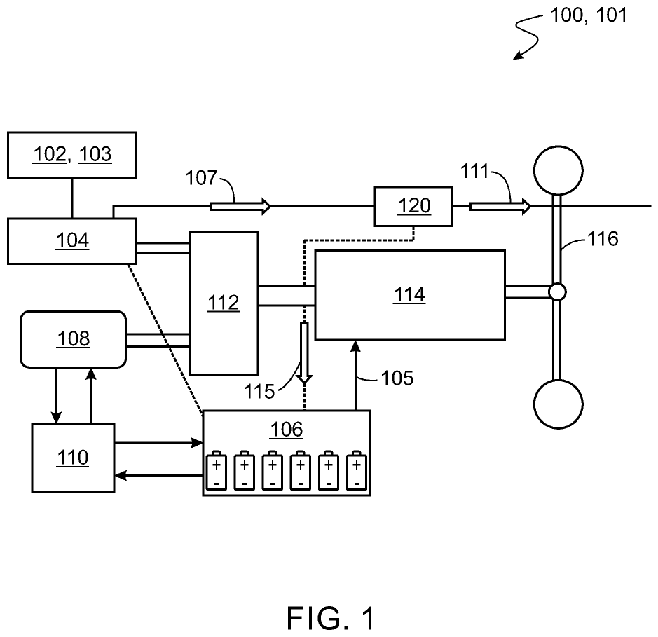

FIG. 1 illustrates an example hybrid vehicle system 100 of a hybrid vehicle 101. The hybrid vehicle system 100 is designed to operate using either fuel 103 (e.g., gasoline, diesel fuel, liquefied petroleum gas, hydrogen, or another type of fuel) as an energy source or electricity 105 as an energy source. Example vehicles 101 that may include the hybrid vehicle system 100 include cars, trucks, and any other types of vehicles. The hybrid vehicle system 100 includes a fuel tank 102 that stores the fuel 103 and an engine 104 that powers the hybrid vehicle system 100 using the fuel 103. The engine 104 outputs relatively hot flue gas 107 as exhaust. The hybrid vehicle system 100 further includes a battery 106 that provides the electricity 105, an electric motor 108 that powers the hybrid vehicle system 100 using the electricity 105, and a motor controller 110 that controls the electric motor 108. The motor controller 110 sends signals to and receives signals from the battery 106 and the electric motor 108.

The hybrid vehicle system 100 also includes a mechanical coupler 112 that receives power either from the engine 104 or alternatively from the electric motor 108 while the hybrid vehicle 101 is in motion. The hybrid vehicle system 100 further includes a mechanical transmission 114 that is operated by the mechanical coupler 112 and a wheel axle 116 that is driven by the mechanical transmission 114 to allow wheels (not shown) of the hybrid vehicle 101 to roll. The mechanical transmission 114 can be powered via the mechanical coupler 112 by the engine 104 or the electric motor 108. Alternatively, or additionally, the mechanical transmission 114 can be powered directly by the battery 106. The battery 106 can be charged by the engine 104 while the engine 104 is operational.

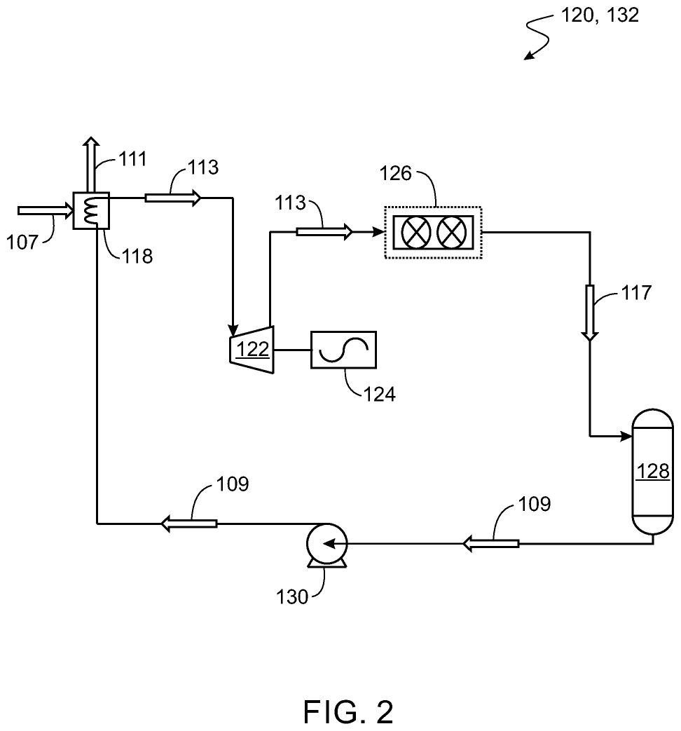

The hybrid vehicle system 100 also includes a special organic rankine cycle (SORC) system 120 that is operable to charge the battery 106 while the hybrid vehicle system 100 is operating on fuel 103. As an input, the SORC system 120 receives relatively hot flue gas 107 that has been combusted from the engine 104. Referring to FIG. 2, the SORC system 120 includes a stage evaporator 118, a turbine 122 (e.g., a turbo-expander), a generator 124, a condenser 126 (e.g., a fin fan air cooler), a vessel 128 (e.g., a surge vessel), and a pump 130.

During operation of the SORC system 120 (e.g., while the hybrid vehicle system 100 is being powered to move by the engine 104), hot flue gas 107 flows into the stage evaporator 118 from the engine 104 while relatively cool liquid refrigerant 109 flows into the stage evaporator 118 from the pump 130. Within the stage evaporator 118, heat from the hot flue gas 107 is transferred to the cool liquid refrigerant 109. Such heat transfer cools the hot flue gas 107, and the stage evaporator 118 combusts and releases the cooled flue gas 111 as waste. Referring again to FIG. 2, the transferred heat causes the liquid refrigerant 109 to vaporize, and the relatively hot, high-pressure, vaporized (e.g., expanded) refrigerant 113 flows to the turbine 122. Using the vaporized refrigerant 113, the turbine 122 produces and outputs mechanical power to the generator 124. Using the mechanical power, the generator 124 produces electricity 115. The generator 124 delivers the electricity 115 to the battery 106 to charge the battery 106 while the engine 104 is operating, as shown in FIG. 1.

The hot vaporized refrigerant 113 flows from the turbine 122 to the condenser 126, which cools the hot vaporized refrigerant 113 to produce condensed refrigerant 117. In some embodiments, the condenser 126 may be provided by a radiator system or an air conditioning system of the hybrid vehicle 101. The condensed refrigerant 117 flows from the condenser 126 to the vessel 126, where the condensed refrigerant 117 collects to form the relatively cool liquid refrigerant 109. The pump 130 pumps the cool liquid refrigerant 109 from the vessel 126 to the stage evaporator 118 in a closed flow loop 132.

Owing to operation of the SORC system 120 via the closed flow loop 132, the SORC captures thermal energy from the hot flue gas 107 to produce electricity 115 that is released to charge the battery 106 while the hybrid vehicle 101 is moving. Within the SORC system 120, a temperature gap between the hot flue gas 107 and the cool flue gas 111 is maintained at about 20° F. above a dew point of the flue gases 107, 111 to prevent water condensation inside of the SORC system 120. In some embodiments, a refrigerant or a mixture of refrigerants that is used in the SORC system 120 is carefully selected to ensure that such refrigerant or mixture is thermodynamically stable and efficient at transferring heat at operational temperatures. In some embodiments, the refrigerant 109, 113, 117 is selected as or includes R-717 (ammonia).

In some embodiments, operation of the SORC system 120 to charge the battery 106 while the hybrid vehicle 101 is running on fuel 103 (e.g., moving) results in a fuel savings of about 20% as compared to the fuel costs of operating of a conventional hybrid vehicle system that does not include the SORC system 120. Such operation also allows the hybrid vehicle 101 to charge relatively quickly in that the charging period is not limited to vehicle coasting and breaking. That is, movement of the hybrid vehicle 101 and charging of the battery 106 can occur simultaneously. The hybrid vehicle system 100 is also configured such that the battery 106 is capable of be fully discharged without being damaged.

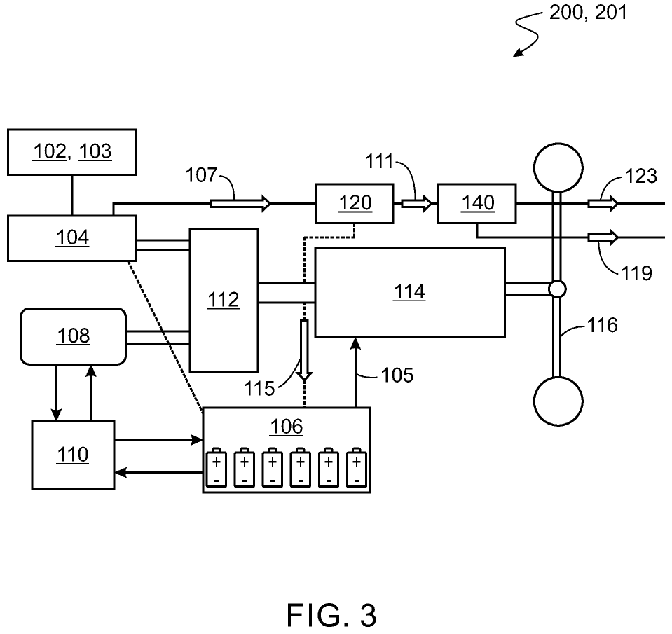

In some embodiments, a hybrid vehicle system that is otherwise substantially similar in construction and function to the hybrid vehicle system 100 additionally includes a water recovery system for vehicles that use hydrogen as a fuel source. For example, referring to FIG. 3, a hybrid vehicle system 200 of a hybrid vehicle 201 uses hydrogen as a fuel source and includes such a water recovery system 140. The hybrid vehicle system 200 is otherwise substantially similar in construction and function to the hybrid vehicle system 100 and accordingly includes the fuel tank 102, the engine 104, the battery 106, the electric motor 108, the motor controller 110, the mechanical coupler 112, the mechanical transmission 114, and the SORC system 120—all of which operate as described above with respect to the hybrid vehicle system 100.

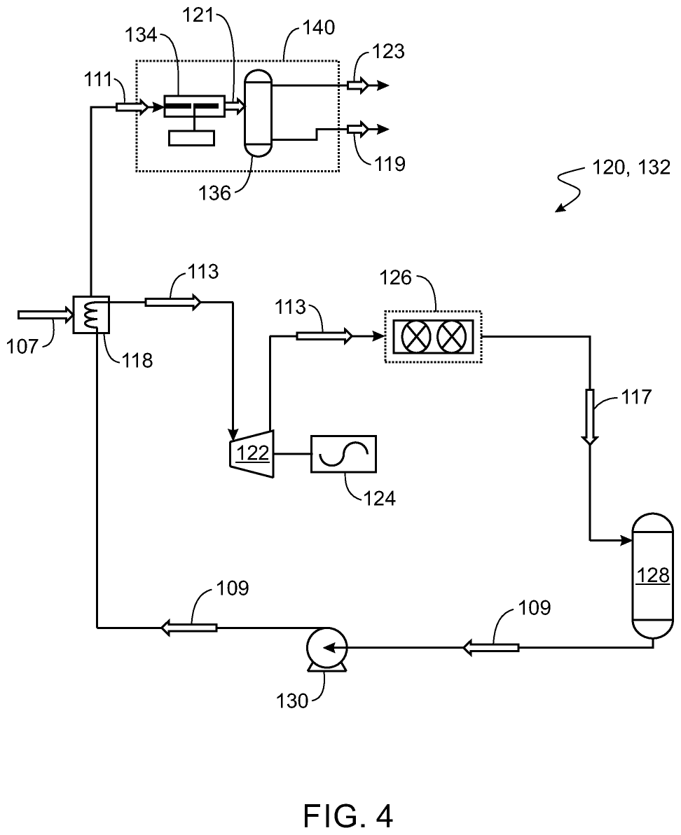

The water recovery system 140 is designed to recover water 119 from the relatively cool flue gas 111 released from the SORC system 120 for washing and cleaning operations. Accordingly, the water recovery system 140 is located downstream of the SORC system 120. The cool flue gas 111 released from the stage evaporator 118 of the SORC system 120 is released at a temperature below a water dew point and with the temperature gap of about 20° F. between the hot glue gas 107 and the cool flue gas 111 to enhance water condensation within the water recovery system 140. Referring to FIG. 4, the water recovery system 140 includes a blower 134 that increases a pressure of the cool flue gas 111 from about 0 psig to about 2 psig to produce pressurized cool flue gas 125. Such increased pressure provides flow assurance and maximizes water recovery. The relatively high pressure flue gas 121 flows from the blower 134 to a vessel 136 (e.g., a collection vessel). Within the vessel 136, water 119 within the high pressure flue gas 121 condenses and accordingly collects for recovery. The remaining flue gas 123 is released from the vessel 136 as waste.

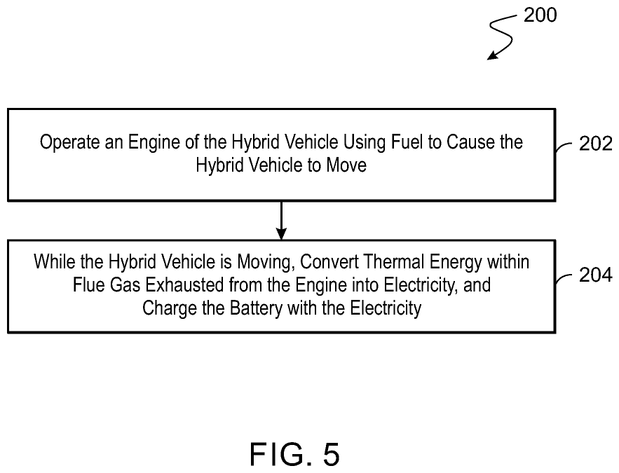

FIG. 5 is a flow chart illustrating an example method 200 of charging a battery (e.g., the battery 106) of a hybrid vehicle (e.g., the hybrid vehicle 101, 201). In some embodiments, the method 200 includes a step 202 for operating an engine (e.g., the engine 104) of the hybrid vehicle using fuel (e.g., the fuel 103) to cause the hybrid vehicle to move. In some embodiments, the method 200 includes a step 204 for, while the hybrid vehicle is moving, converting thermal energy within flue gas exhausted from the engine into electricity (e.g., the electricity 115) and charging the battery with the electricity.

While the systems 100, 120, 140, 200 have been described and illustrated with respect to certain dimensions, sizes, shapes, arrangements, materials, and methods 200, in some embodiments, a system that is otherwise substantially similar in construction and function to any of the systems 100, 120, 140, 200 may include one or more different dimensions, sizes, shapes, arrangements, configurations, and materials or may be utilized according to different methods.

Accordingly, other embodiments are also within the scope of the following claims.

What is claimed is:

1. A method of charging a battery of a hybrid vehicle, the method comprising:
operating an engine of the hybrid vehicle using fuel to cause the hybrid vehicle to move; and
while the hybrid vehicle is moving:
converting thermal energy within flue gas exhausted from the engine into electricity, and
charging the battery with the electricity.

2. The method of claim 1, further comprising flowing the flue gas exhausted from the engine into an evaporator.

3. The method of claim 2, wherein the flue gas is relatively hot flue gas, and wherein the method further comprises:
vaporizing liquid refrigerant within the evaporator using heat from the relatively hot flue gas; and
releasing relatively cold flue gas from the evaporator.

4. The method of claim 3, further comprising maintaining a temperature difference of about 20° F. between the relatively hot flue gas and the relatively cold flue gas.

5. The method of claim 3, further comprising generating the electricity from vaporized refrigerant flowing from the evaporator.

6. The method of claim 5, further comprising:
flowing the vaporized refrigerant from the evaporator to a turbine;
generating the electricity at a generator; and
releasing the electricity from the generator to the battery.

7. The method of claim 3, further comprising condensing the vaporized refrigerant.

8. The method of claim 7, wherein a radiator system or an air conditioning system of the hybrid vehicle provides a cooling functionality.

9. The method of claim 2, wherein the hybrid vehicle further comprises a special rankine organic cycle (SORC) system that comprises the evaporator.

10. The method of claim 9, further comprising flowing refrigerant through a closed loop of the SORC system.

11. The method of claim 10, wherein the refrigerant includes R-717.

12. The method of claim 1, further comprising recovering water from the flue gas exhausted from the engine while the hybrid vehicle is moving.

13. The method of claim 12, further comprising cooling the flue gas exhausted from the engine in a water recovery system of the hybrid vehicle.

14. The method of claim 12, further comprising increasing a pressure of the flue gas prior to recovering the water.

15. A method of operating a hybrid vehicle, the method comprising:
operating an engine of the hybrid vehicle using fuel to cause the hybrid vehicle to move; and
while the hybrid vehicle is moving:
converting thermal energy within flue gas exhausted from the engine into electricity,
charging the battery with the electricity, and
recovering water from the flue gas.
